(19) United States
(12) Patent Application Publication
(10) Pub. No.: US 2022/0398935 A1
(43) Pub. Date: Dec. 15, 2022

(54) TRAINING MODE SIMULATOR

(71) Applicant: STEERING SOLUTIONS IP HOLDING CORPORATION, Saginaw, MI (US)

(72) Inventors: Larry J. Wilson, Saint Clair Shores, MI (US); Joachim J. Klesing, Rochester, MI (US); Michael R. Story, Bay City, MI (US); Peter D. Schmitt, Farmington Hills, MI (US); Farhad Bolourchi, Novi, MI (US); Mariam S. George, Lake Orion, MI (US)

(21) Appl. No.: 17/346,877

(22) Filed: Jun. 14, 2021

(51) Int. Cl. G09B 9/052; G09B 9/042; G07C 5/00

(52) U.S. Cl. CPC G09B 9/052; G09B 9/042; G07C 5/008

(57) ABSTRACT

A method for vehicle operating session simulation includes receiving, at a server computing device, vehicle data representing characteristics of a vehicle during a vehicle operating session and identifying a first actual value of the vehicle data corresponding to at least one operator input provided during a corresponding segment of the vehicle operating session. The method also includes determining, using the vehicle data, a first expected value corresponding to the first actual value and, in response to a determination that the first actual value is outside of a range of the first expected value, generating a vehicle simulation corresponding to the segment. The method also includes providing, at one or more simulation interfaces, the vehicle simulation.

### TECHNICAL FIELD

This disclosure related to vehicle simulators and in particular to systems and methods for a training mode simulator.

### BACKGROUND

Vehicles, such as cars, trucks, sport utility vehicles, crossovers, mini-vans, marine craft, aircraft, all-terrain vehicles, recreational vehicles, or other suitable vehicles, include a steering system, such as an electronic power steering (EPS) system, a steer-by-wire steering system, or other suitable steering system. Vehicle operation typically involves engaging, by an operator, one or more operator input devices, including one or more operator input devices of the steering system, one or more operating input devices of a propulsion system, one or more operating input devices of a signaling system, and the like.

Typically, relatively inexperienced drivers lack the confidence or skills to operate a vehicle on busy roads with traffic, at night, in in climate weather, and the like. Typically, using turning inputs and/or throttle inputs may be unsafe and/or operate erratically. Traditionally, vehicle operators receive a, relatively short, one-on-one instruction provided by an experienced vehicle operator instructor. In some cases, this may be suitable for a vehicle operator. In other cases, the vehicle operator may desire to receive further training in order to improve vehicle operation confidence and skills.

### SUMMARY

This disclosure relates generally to vehicle operating session simulators.

An aspect of the disclosed embodiments includes a method for vehicle operating session simulation. The method includes receiving, at a server computing device, vehicle data representing characteristics of a vehicle during a vehicle operating session and identifying a first actual value of the vehicle data corresponding to at least one operator input provided during a corresponding segment of the vehicle operating session. The method also includes determining, using the vehicle data, a first expected value corresponding to the first actual value and, in response to a determination that the first actual value is outside of a range of the first expected value, generating a vehicle simulation corresponding to the segment. The method also includes providing, at one or more simulation interfaces, the vehicle simulation.

Another aspect of the disclosed embodiments includes a system for vehicle operating session simulation. The system includes a processor and a memory. The memory includes instructions that, when executed by the processor, cause the processor to: receive vehicle data representing characteristics of a vehicle during a vehicle operating session; identify a first actual value of the vehicle data corresponding to at least one operator input provided during a corresponding segment of the vehicle operating session; determine, using the vehicle data, a first expected value corresponding to the first actual value; in response to a determination that the first actual value is outside of a range of the first expected value, generate a vehicle simulation corresponding to the segment; and provide, at one or more simulation interfaces, the vehicle simulation.

Another aspect of the disclosed embodiments includes an apparatus for vehicle operating session simulation. The apparatus includes a processor and a memory. The memory includes instructions that, when executed by the processor, cause the processor to: receive, from a controller associated with a vehicle, vehicle data representing characteristics of the vehicle during a vehicle operating session, the vehicle data being generated by the controller in response to a simulation mode input indicating a start of the vehicle operating session; identify a first actual value of the vehicle data corresponding to at least one operator input provided during a corresponding segment of the vehicle operating session, the at least one operator input being associated with at least one component of a steering system of the vehicle; determine, using the vehicle data, a first expected value corresponding to the first actual value; in response to a determination that the first actual value is outside of a range of the first expected value, generate a vehicle simulation corresponding to the segment; and provide, at one or more simulation interfaces, the vehicle simulation.

These and other aspects of the present disclosure are disclosed in the following detailed description of the embodiments, the appended claims, and the accompanying figures.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 generally illustrates a vehicle according to the principles of the present disclosure.

FIG. 2 generally illustrates a vehicle operation simulation system according to the principles of the present disclosure.

FIG. 3 is a flow diagram generally illustrating a vehicle data recoding method according to the principles of the present disclosure.

FIG. 4 is a flow diagram generally illustrating a vehicle operating simulation generation method according to the principles of the present disclosure.

FIG. 5 is a flow diagram generally illustrating a vehicle operating simulation execution method according to the principles of the present disclosure.

FIG. 6 is a flow diagram generally illustrating a vehicle operating simulation scoring method according to the principles of the present disclosure.

### DETAILED DESCRIPTION

The following discussion is directed to various embodiments of the disclosure. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

As described, vehicles, such as cars, trucks, sport utility vehicles, crossovers, mini-vans, marine craft, aircraft, all-terrain vehicles, recreational vehicles, or other suitable vehicles, include a steering system, such as an electronic power steering (EPS) system, a steer-by-wire steering system, or other suitable steering system. Vehicle operation typically involves engaging, by an operator, one or more operator input devices, including one or more operator input devices of the steering system, one or more operating input devices of a propulsion system, one or more operating input devices of a signaling system, and the like.

Typically, relatively inexperienced drivers lack the confidence or skills to operate a vehicle on busy roads with traffic, at night, in in climate weather, and the like. Typically, using turning inputs and/or throttle inputs may be unsafe and/or operate erratically. Traditionally, vehicle operators receive a, relatively short, one-on-one instruction provided by an experienced vehicle operator instructor. In some cases, this may be suitable for a vehicle operator. In other cases, the vehicle operator may desire to receive further training in order to improve vehicle operation confidence and skills.

Accordingly, systems and methods, such as those described herein, configured to provide, to an operator of a vehicle (e.g., such as an inexperienced operator desiring to improve vehicle operating confidence and skills, an operator of an autonomous or semi-autonomous vehicle desiring to maintain or improve vehicle operating confidence of skills, an operator of a performance vehicle, an operator of a utility or construction vehicle, and the like), a vehicle training simulation (e.g., using previously record data corresponding to a vehicle operating session), may be desirable.

In some embodiments, the systems and methods described herein may be configured to allow the operator to practice operating the vehicle in a safe environment (e.g., such as in the vehicle while a transition of the vehicle is in park or on a computing device away from the vehicle). The systems and methods described herein may be configured to allow the operator to learn from past vehicle operating sessions while the vehicle is in park.

In some embodiments, the systems and methods described herein may be configured to provide the vehicle training simulation in commercial vehicle, a performance vehicle (e.g., a racing vehicle and the like), and/or other suitable vehicle. The systems and methods described herein may be configured to record a vehicle operating session. The systems and methods described herein may be configured to select opportunities where the operator performed differently than an expected performance during an operating scenario of a segment of the vehicle operating session. For example, the operator drove to fast during a segment of the vehicle operating session, the operator did not stop at an intersection during the vehicle operating session, the operator did not perform a smooth a turn during a segment of the vehicle operating session, other suitable scenario performance, or a combination there.

In some embodiments, the systems and methods described herein may be configured to present the scenarios to the operator using one or more simulation interfaces, such as a vehicle heads-up display (HUD), a smart glass, a television in the vehicle or remote from the vehicle, one or more enhanced reality interfaces (e.g., goggles, displays, audio outputs, and the like), other suitable interfaces, or a combination thereof. The operator may replay the scenarios using the simulation interfaces and one or more operator inputs, such as a handwheel, an accelerator pedal, a decelerator pedal, a signal indicator, and the like, to control a simulated version of the vehicle on a simulated vehicle operator session. The systems and methods described herein may be configured to may allow the operator practice the same maneuver in the vehicle to feel comfortable in that situation, at a particular intersection, and/or other suitable segment of the vehicle operating session.

In some embodiments, the systems and methods described herein may be configured to record the vehicle data of the vehicle operating session in response to the operator turning on a vehicle simulation mode. The systems and methods described herein may be configured to complete recording the vehicle data of the vehicle operating session in response to the simulation mode being turned off. The simulation mode may be turned off by the operator, by the vehicle being in a park gear, by the vehicle coming to a complete stop, or other suitable event.

The systems and methods described herein may be configured to upload the vehicle data to a remote computing device, such as a cloud server or other suitable remote computing device. The systems and methods described herein may be configured to, using the remote computing device, analyze the vehicle data. The systems and methods described herein may be configured to generate or calculate a grade or score for at least a segment of the vehicle operating session. The systems and methods described herein may be configured to generate the grade or score based on how well the operator performed maneuvers, such as but not limited to right and left hand turns, changing lanes in traffic, following behind lead vehicles, maintaining a vehicle speed relative to a speed limit, other suitable maneuvers, or a combination thereof.

The systems and methods described herein may be configured to present areas for the operator to improve and/or practice if needed. The systems and methods described herein may be configured to, during performance of the vehicle simulation, act as a vehicle operating simulator with the vehicle being stationary by using steer-by-wire, electronic brake and electronic throttle, and/or other systems or components of the vehicle.

In some embodiments, the systems and methods described herein may be configured to provide a “learn” a track or course feature, which may allow the operator to actually operate the vehicle on a particular track or course. The systems and methods described herein may be configured to allow the operator to set the simulation mode of the vehicle to learn the curves, terrain, road elevation changes, and the like of a particular track or course. The systems and methods described herein may be configured to generate an optimum path around the course or track and evaluate how well the operator performed during a corresponding vehicle operating session.

In some embodiments, the systems and methods described herein may be configured to record data in response to the vehicle simulation mode being activated by the operator. The systems and methods described herein may be configured provide instructions the vehicle operator to improve turning or other vehicle trajectories, to improve energy consumption using calculations and/or algorithms related to tire slip, and the like. The systems and methods described herein may be configured to record data, such as but not limited to: steering angle, steering torque, driver torque, rack force, road surface, lane position, gear position, traffic light data, vehicle camera data, global positioning system data, vehicle speed, speed limit information, brake pedal data, throttle position, vehicle pitch and roll, longitudinal acceleration, deceleration, vehicle signal indication, and the like.

In some embodiments, the systems and methods described herein may be configured to receive, at a server computing device, vehicle data representing characteristics of a vehicle during a vehicle operating session. The server computing device may be remotely located from the vehicle. In some embodiments, the vehicle data includes at least one of steering system data, vehicle propulsion data, global positioning data, environmental data, traffic data, traffic control data, other suitable data, or a combination thereof. In some embodiments, the vehicle operating session corresponds to a period of vehicle operation initiated in response to a first simulation mode input corresponding to a simulation mode interface. In some embodiments, the period of vehicle operation of the vehicle operating session concludes in response to a second simulation mode input. In some embodiments, the second simulation mode input corresponds to at least one of the simulation mode interface, vehicle position, a vehicle speed, a vehicle gear position, an ignition switch position, other suitable input, or a combination thereof.

The systems and methods described herein may be configured to identify a first actual value of the vehicle data corresponding to at least one operator input provided during a corresponding segment of the vehicle operating session. In some embodiments, the segment corresponds to a portion of the vehicle operating session that includes at least one of a vehicle turn, a vehicle stop, a vehicle acceleration, a vehicle deceleration, other suitable vehicle scenarios or maneuvers, or a combination thereof.

The systems and methods described herein may be configured to determine, using the vehicle data, a first expected value corresponding to the first actual value. The systems and methods described herein may be configured to, in response to a determination that the first actual value is outside of a range of the first expected value, generate a vehicle simulation corresponding to the segment.

The systems and methods described herein may be configured to provide, at one or more simulation interfaces, the vehicle simulation. In some embodiments, the one or more simulation interfaces includes one or more of a heads-up display of the vehicle, a display associated with an infotainment system of the vehicle, one or more enhanced reality devices, one or more audio output devices, one or more operator input devices of the vehicle, a mobile computing device, other suitable interfaces, or a combination thereof. In some embodiments, the one or more operator input devices of the vehicle includes at least one of a handwheel, an accelerator interface, a decelerator interface, a signal indicator, other suitable input device, or a combination thereof. In some embodiments, the systems and methods described herein may be configured to generate, using the vehicle data, a vehicle operating session score.

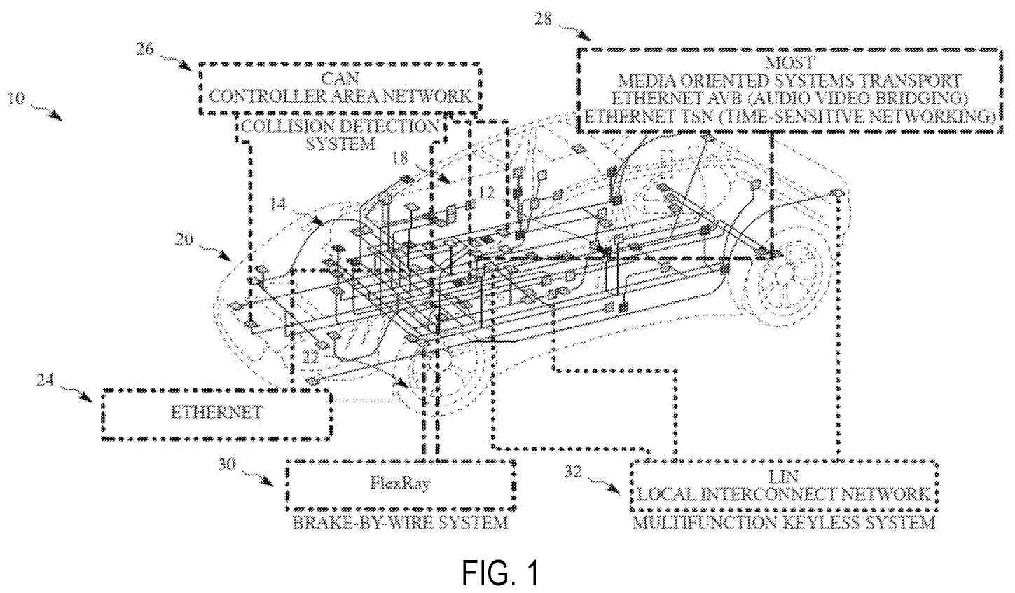

FIG. 1 generally illustrates a vehicle 10 according to the principles of the present disclosure. The vehicle 10 may include any suitable vehicle, such as a car, a truck, a sport utility vehicle, a mini-van, a crossover, any other passenger vehicle, any suitable commercial vehicle, or any other suitable vehicle. While the vehicle 10 is illustrated as a passenger vehicle having wheels and for use on roads, the principles of the present disclosure may apply to other vehicles, such as planes, boats, trains, drones, or other suitable vehicles.

The vehicle 10 includes a vehicle body 12 and a hood 14. A passenger compartment 18 is at least partially defined by the vehicle body 12. Another portion of the vehicle body 12 defines an engine compartment 20. The hood 14 may be moveably attached to a portion of the vehicle body 12, such that the hood 14 provides access to the engine compartment 20 when the hood 14 is in a first or open position and the hood 14 covers the engine compartment 20 when the hood 14 is in a second or closed position. In some embodiments, the engine compartment 20 may be disposed on rearward portion of the vehicle 10 than is generally illustrated.

The passenger compartment 18 may be disposed rearward of the engine compartment 20, but may be disposed forward of the engine compartment 20 in embodiments where the engine compartment 20 is disposed on the rearward portion of the vehicle 10. The vehicle 10 may include any suitable propulsion system including an internal combustion engine, one or more electric motors (e.g., an electric vehicle), one or more fuel cells, a hybrid (e.g., a hybrid vehicle) propulsion system comprising a combination of an internal combustion engine, one or more electric motors, and/or any other suitable propulsion system.

In some embodiments, the vehicle 10 may include a petrol or gasoline fuel engine, such as a spark ignition engine. In some embodiments, the vehicle 10 may include a diesel fuel engine, such as a compression ignition engine. The engine compartment 20 houses and/or encloses at least some components of the propulsion system of the vehicle 10. Additionally, or alternatively, propulsion controls, such as an accelerator actuator (e.g., an accelerator pedal), a brake actuator (e.g., a brake pedal), a steering wheel, and other such components are disposed in the passenger compartment 18 of the vehicle 10. The propulsion controls may be actuated or controlled by a driver of the vehicle 10 and may be directly connected to corresponding components of the propulsion system, such as a throttle, a brake, a vehicle axle, a vehicle transmission, and the like, respectively. In some embodiments, the propulsion controls may communicate signals to a vehicle computer (e.g., drive by wire) which in turn may control the corresponding propulsion component of the propulsion system. As such, in some embodiments, the vehicle 10 may be an autonomous vehicle.

In some embodiments, the vehicle 10 includes a transmission in communication with a crankshaft via a flywheel or clutch or fluid coupling. In some embodiments, the transmission includes a manual transmission. In some embodiments, the transmission includes an automatic transmission. The vehicle 10 may include one or more pistons, in the case of an internal combustion engine or a hybrid vehicle, which cooperatively operate with the crankshaft to generate force, which is translated through the transmission to one or more axles, which turns wheels 22. When the vehicle 10 includes one or more electric motors, a vehicle battery, and/or fuel cell provides energy to the electric motors to turn the wheels 22.

The vehicle 10 may include automatic vehicle propulsion systems, such as a cruise control, an adaptive cruise control, automatic braking control, other automatic vehicle propulsion systems, or a combination thereof. The vehicle 10 may be an autonomous or semi-autonomous vehicle, or other suitable type of vehicle. The vehicle 10 may include additional or fewer features than those generally illustrated and/or disclosed herein.

In some embodiments, the vehicle 10 may include an Ethernet component 24, a controller area network (CAN) bus 26, a media oriented systems transport component (MOST) 28, a FlexRay component 30 (e.g., brake-by-wire system, and the like), and a local interconnect network component (LIN) 32. The vehicle 10 may use the CAN bus 26, the MOST 28, the FlexRay component 30, the LIN 32, other suitable networks or communication systems, or a combination thereof to communicate various information from, for example, sensors within or external to the vehicle, to, for example, various processors or controllers within or external to the vehicle. The vehicle 10 may include additional or fewer features than those generally illustrated and/or disclosed herein.

In some embodiments, the vehicle 10 may include a steering system, such as a steer-by-wire steering system or other suitable steering system. For example, the steering system may include or communicate with one or more controllers that control components of the steering system without the use of mechanical connection between the handwheel and roadwheels of the vehicle 10. The steering system may include an open-loop feedback control system or mechanism, a closed-loop feedback control system or mechanism, or combination thereof. The steering system may be configured to receive various inputs, including, but not limited to, a handwheel position, an input torque, one or more roadwheel positions, other suitable inputs or information, or a combination thereof. Additionally, or alternatively, the inputs may include a handwheel torque, a handwheel angle, a motor velocity, a vehicle speed, an estimated motor torque command, other suitable input, or a combination thereof. The steering system may be configured to provide steering function and/or control to the vehicle 10. For example, the steering system may generate an assist torque based on the various inputs. The steering system may be configured to selectively control a motor of the steering system using the assist torque to provide steering assist to the operator of the vehicle 10.

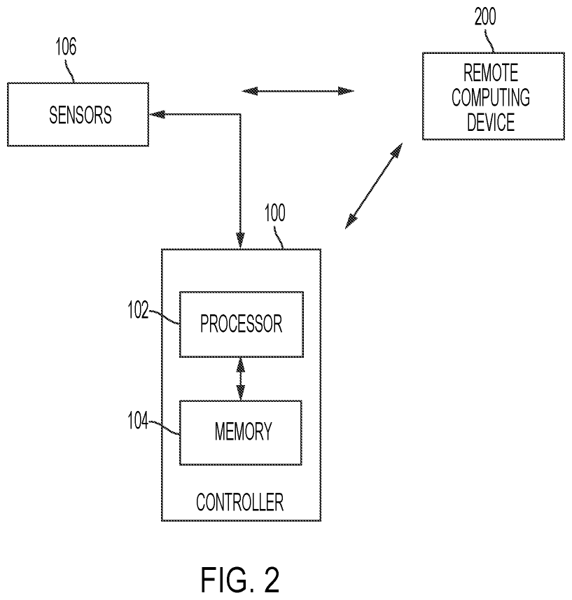

In some embodiments, the vehicle 10 may include a controller, such as controller 100, as is generally illustrated in FIG. 2. The controller 100 may include any suitable controller, such as an electronic control unit or other suitable controller. The controller 100 may be configured to control, for example, the various functions of the steering system and/or various functions of the vehicle 10. The controller 100 may include a processor 102 and a memory 104. The processor 102 may include any suitable processor, such as those described herein. Additionally, or alternatively, the controller 100 may include any suitable number of processors, in addition to or other than the processor 102. The memory 104 may comprise a single disk or a plurality of disks (e.g., hard drives), and includes a storage management module that manages one or more partitions within the memory 104. In some embodiments, memory 104 may include flash memory, semiconductor (solid state) memory or the like. The memory 104 may include Random Access Memory (RAM), a Read-Only Memory (ROM), or a combination thereof. The memory 104 may include instructions that, when executed by the processor 102, cause the processor 102 to, at least, control various aspects of the vehicle 10.

The controller 100 may receive one or more signals from various measurement devices or sensors 106 indicating sensed or measured characteristics of the vehicle 10. The sensors 106 may include any suitable sensors, measurement devices, and/or other suitable mechanisms. For example, the sensors 106 may include one or more torque sensors or devices, one or more handwheel position sensors or devices, one or more motor position sensor or devices, one or more position sensors or devices, other suitable sensors or devices, or a combination thereof. The one or more signals may indicate a handwheel torque, a handwheel angel, a motor velocity, a vehicle speed, other suitable information, or a combination thereof.

In some embodiments, the sensors 106 may include one or more image capturing devices (e.g., such as a camera), one or more audio input devices (e.g. such as a microphone), one or more global positioning devices, one or more proximity sensing devices, other suitable sensors or devices, or a combination thereof.

In some embodiments, the controller 100 may communicate with remote computing device 200. The remote computing device 200 may be disposed within the vehicle 10 or be remotely located (e.g., on a computing device such as a mobile computing device or other suitable computing device or on a remotely located computing server, such as a cloud computing device, or other suitable remotely located computing device). The remote computing device 200 may include any suitable computing device, such as a mobile computing device, a laptop computing device, a desktop computing device, a server-computing device, or any other suitable computing device.

The remote computing device 200 may include a processor configured to control the overall operation of remote computing device 200. The processor may include any suitable processor, such as those described herein. Additionally, or alternatively, the remote computing device 200 may include one or more processors including and/or in addition to the processor. The remote computing device 200 may also include a user input device that is configured to receive input from a user of the remote computing device 200 and to communicate signals representing the input received from the user to the processor. For example, the user input device may include a button, keypad, dial, touch screen, audio input interface, visual/image capture input interface, input in the form of sensor data, and the like.

The remote computing device 200 may include a display that may be controlled by the processor to display information to a user. A data bus may be configured to facilitate data transfer between, at least, a storage device and the processor. The remote computing device 200 may also include a network interface configured to couple or connect the remote computing device 200 to various other computing devices or network devices via a network connection, such as a wired or wireless connection. In some embodiments, the network interface includes a wireless transceiver.

The storage device may comprise a single disk or a plurality of disks (e.g., hard drives), one or more solid-state drives, one or more hybrid hard drives, and the like. The storage device may include a storage management module that manages one or more partitions within the storage device. In some embodiments, storage device may flash memory, semiconductor (solid state) memory or the like. The remote computing device 200 may also include a memory. The memory may include Random Access Memory (RAM), a Read-Only Memory (ROM), or a combination thereof. The memory may store programs, utilities, or processes to be executed in by the processor. The memory may provide volatile data storage, and stores instructions related to the operation of the remote computing device 200.

In some embodiments, the memory may include instructions that, when executed by the processor, case the processor to perform various techniques, such as those described herein.

In some embodiments, remote computing device 200 may receive, from at least one of the controller 100 and the sensors 106, vehicle data representing characteristics of the vehicle 10 during a vehicle operating session. In some embodiments, the vehicle data may include at least one of steering system data, vehicle propulsion data (e.g., including acceleration data, deceleration data, vehicle speed data), global positioning data, environmental data, traffic data, traffic control data, other suitable data, or a combination thereof. For example, the controller 100 may receive the various signals from the sensors 106. Additionally, or alternatively, the controller 100 may receive traffic data, environmental data, traffic control data (e.g., a location of stop signs, posted speed limits, traffic light locations and status or timing, and the like). The controller 100 may receive such data from a remote computing device, such as the remote computing device 200, or from a mobile computing device disposed in the vehicle 10, a dedicated server remotely located from the vehicle 10, one or more other vehicles in communication with the vehicle 10, or other suitable source.

In some embodiments, the vehicle operating session corresponds to a period of vehicle operation initiated in response to a first simulation mode input corresponding to a simulation mode interface. The simulation mode interface may include a switch or digital interface (e.g., such as an application associated with an infotainment system or other suitable system within the vehicle 10 or an application disposed on a mobile computing device). The operator may interface with the interface to enable the vehicle simulation mode. In some embodiments, the first simulation mode input may correspond to an ignition switch position (e.g., in the closed or on position), a change in vehicle gear position (e.g., from park to drive, or other suitable change), other suitable input, or a combination thereof. The controller 100 may receive the first simulation mode input and may begin capturing the vehicle data as the operator operates the vehicle 10.

In some embodiments, the period of vehicle operation of the vehicle operating session concludes in response to a second simulation mode input. In some embodiments, the second simulation mode input may correspond to an input received from the simulation model interface. For example, after a desired period, the operator may interact with the simulation mode interface to disable the vehicle simulation mode. Additionally, or alternatively, the second simulation mode input may correspond to vehicle position (e.g., such as a location of the vehicle 10, for example, at a destination or end point of a route being traversed by the vehicle 10), a vehicle speed (e.g., such as below or above a speed threshold), a vehicle gear position (e.g., such as a park position, a revers position, or other suitable position), an ignition switch position (e.g., a change in ignition switch position from closed to open (on to off)), other suitable input, or a combination thereof. Corresponds to at least one of the simulation mode interface, vehicle position, a vehicle speed, a vehicle gear position, an ignition switch position, other suitable input, or a combination thereof. The controller 100 may receive the second simulation mode input and may discontinue capturing the vehicle data. The controller 100 may store, in the memory 104 or other suitable location, the vehicle data corresponding to the vehicle operating session.

The controller 100 may provide (e.g., transmit or communicate) the vehicle data to the remote computing device 200. The controller 100 may provide the vehicle data to the remote computing device 200 using any suitable communications protocol via any suitable network, such as the Internet or other suitable network. The remote computing device 200 my analyze the vehicle data and identify a first actual value of the vehicle data corresponding to at least one operator input provided during a corresponding segment of the vehicle operating session. In some embodiments, the segment corresponds to a portion of the vehicle operating session that includes at least one vehicle maneuver. The at least one vehicle maneuver may include at least one of a vehicle turn, a vehicle stop (e.g., at a traffic light, stop sign, behind a lead vehicle, and the like), a vehicle acceleration (e.g., from a stop, a lower speed, or in response to a change in speed limit), a vehicle deceleration (e.g., during traffic, in response to a change in speed limit, approaching a stop, and the like), a vehicle speed, other suitable vehicle maneuver, or a combination thereof.

The first actual value may correspond to a value of the vehicle data corresponding to the segment, such as a handwheel angle, a vehicle speed, a yaw rate, a lateral acceleration, a roll rate, a deceleration, an acceleration, a roadwheel angle, a signal indicator status (e.g., a turn signal status), vehicle position, other suitable value, or a combination thereof. For example, the first actual value may include a handwheel angle during a turning maneuver associated with the segment. In some embodiments, the remote computing device 200 may identify a plurality of actual values associated with the segment. For example, the remote computing device 200 may identify a steering angle, a vehicle speed, a yaw rate, other suitable value, or a combination thereof.

The remote computing device 200 may determine, using the vehicle data, a first expected value corresponding to the first actual value. For example, the remote computing device 200 may identify, using the vehicle data, a vehicle speed limit corresponding to the segment, an angle of a turn associated with the segment, one or more traffic control devices (e.g., traffic light, stop sign, and the like) associated with the segment, other suitable data associated with the segment, or a combination thereof. The remote computing device 200 may determine the first expected value based on the vehicle data associated with the segment. For example, the remote computing device 200 may determine that an expected speed limit for the segment corresponds to a posted speed limit.

Additionally, or alternatively, the remote computing device 200 may determine an expected handwheel angle, roadwheel angle, and the like for a turn associated with the segment based on an angle of the turn and/or other characteristics of the segment. The first expected value may correspond to a required value (e.g., such as a speed limit) and/or a safety value (e.g., a value that provided a safe execution of the maneuver) of the segment. In some embodiments, the remote computing device 200 may retrieve a predetermined expected value corresponding to the first actual value from a suitable storage mechanism, such as a memory or database associated with the remote computing device 200.

The remote computing device 200 may determine whether the first actual value is within a range of the first expected value. The range may include any suitable range greater than or less than the first expected value. In some embodiments, the range may be predefined. In some embodiments, the remote computing device 200 may set the range based on an operating history of the operator, an experience of the operator, input provided by the operator, input provided by a surrogate for the operator, and/or the like. The remote computing device 200 may, in response to a determination that the first actual value is within the range of the first expected value, identify another segment of the vehicle operating session and/or another maneuver associated with the segment. The remote computing device 200 may continue as described.

Conversely, the remote computing device 200 may, in response to a determination that the first actual value is outside of the range of the first expected value, generate a vehicle simulation corresponding to the segment. The vehicle simulation may include information configured to allow the operator to replay, using one or more simulation interfaces, at least the maneuver of the segment, as will be described.

The remote computing device 200 may provide, at one or more simulation interfaces, the vehicle simulation. For example, the remote computing device 200 may communicate with the one or more simulation interfaces, the remote computing device 200 may communicate with the controller 100, which communicates with the one or more simulation interfaces, or a combination thereof. The one or more simulation interfaces includes one or more of a heads-up display of the vehicle, a display associated with an infotainment system of the vehicle, one or more enhanced reality devices, one or more audio output devices, one or more operator input devices of the vehicle, a mobile computing device, other suitable interfaces, or a combination thereof. The one or more operator input devices of the vehicle includes at least one of a handwheel, an accelerator interface, a decelerator interface, a signal indicator, other suitable input device, or a combination thereof.

In some embodiments, the controller 100 provides the vehicle simulation to the one or more simulation interfaces. For example, the controller 100 may display a simulated version of the maneuver associated with the segment on a display. The operator may use the one or more operator inputs to virtually control the vehicle 10 to execute the maneuver, while the vehicle 10 transmission is in park or other suitable status of the vehicle 10. The controller 100 may capture data associated with the virtual control of the vehicle 10 during execution of the vehicle simulation. The controller 100 may provide the data to the remote computing device 200.

In some embodiments, remote computing device 200 may generate one or more scores. For example, the remote computing device 200 may generate a vehicle operating session score, using the vehicle data, corresponding to the vehicle operating session. Additionally, or alternatively, the remote computing device 200 may generate a segment score, using the vehicle data associated with the segment. Additionally, or alternatively, the remote computing device 200 may generate a virtual control score, using the data captured during execution of the vehicle simulation. The remote computing device 200 may generate the one or more scores by comparing various actual values to corresponding expected values, as described. The one or more scores may represent a positive performance rate of the operator during vehicle operations and/or virtual control of the vehicle 10, generating, using the vehicle data, a vehicle operating session score.

In some embodiments, the controller 100 and/or the remote computing device 200 may perform the methods described herein. However, the methods described herein as performed by the controller 100 and/or the remote computing device 200 are not meant to be limiting, and any type of software executed on a controller or processor can perform the methods described herein without departing from the scope of this disclosure. For example, a controller, such as a processor executing software within a computing device, can perform the methods described herein.

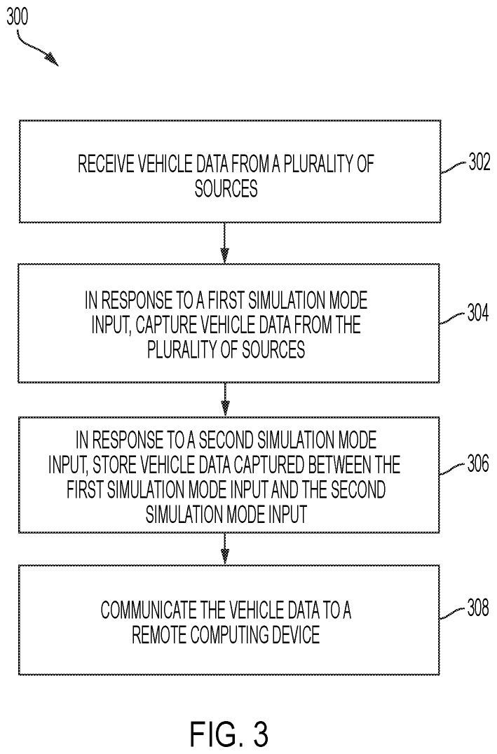

FIG. 3 is a flow diagram generally illustrating a vehicle data recording method 300 according to the principles of the present disclosure. At 302, the method 300 receives vehicle data from a plurality of sources. For example, the controller 100 receives vehicle data from a plurality of sources, such as the sensors 106, the remote computing device 200, and/or any other suitable source.

At 304, the method 300, in response to a first simulation mode input, captures vehicle data from the plurality of sources. For example, the controller 100 may receive the first simulation input. The first simulation input may be associated with the simulation mode interface and/or any other suitable input, such as those described herein. The controller 100 may initiate capturing the vehicle data in response to receiving the first simulation mode input.

At 306, the method 300, in response to a second simulation mode input, stores the vehicle data captured between the first simulation mode input and the second simulation mode input. For example, the controller 100 may receive the second simulation mode input. The second simulation mode input may be associated with the simulation mode interface and/or any other suitable input, such as those described herein. The controller 100 may discontinue capturing the vehicle data in response to the second simulation mode input. The controller 100 may store the vehicle data captured between receiving the first simulation mode input and the second simulation mode input. In some embodiments, the controller 100 may continue to capture the vehicle data after storing the vehicle data captured between receiving the first simulation mode input and the second simulation mode input.

At 308, the method 300 communicates the vehicle data to a remote computing device. For example, the controller 100 may communicate the vehicle data to the remote computing device 200.

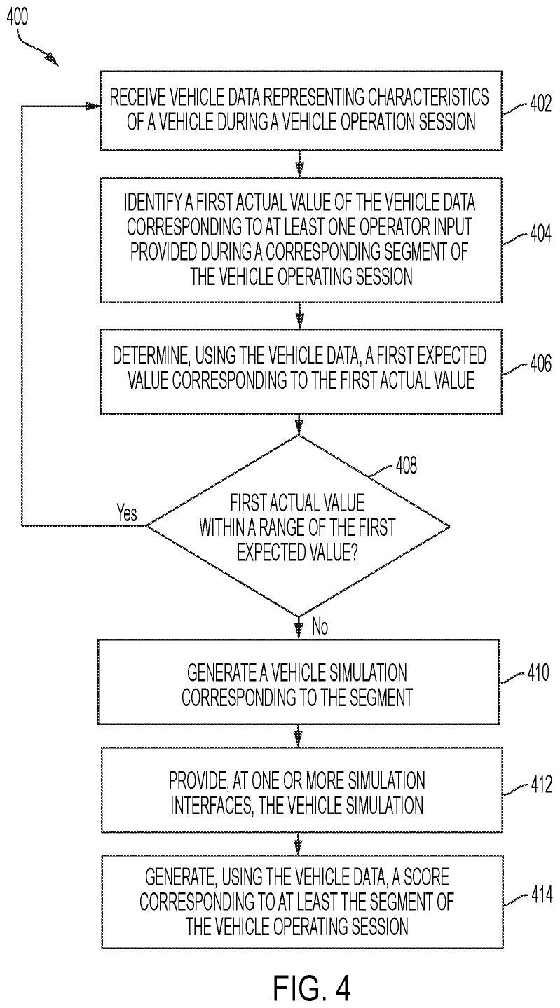

FIG. 4 is a flow diagram generally illustrating a vehicle operating simulation generation method 400 according to the principles of the present disclosure. At 402, the method 400 receives vehicle data representing characteristics of a vehicle during a vehicle operating session. For example, the remote computing device 200 may receive the vehicle data representing characteristics of the vehicle 10 during the vehicle operating session.

At 404, the method 400 identifies a first actual value of the vehicle data corresponding to at least one operator input provided during a corresponding segment of the vehicle operating session. For example, the remote computing device 200 may identify the first actual value of the vehicle data. The first actual value may correspond to at least one operator input provided during the corresponding segment of the vehicle operating session.

At 406, the method 400 determines, using the vehicle data, a first expected value corresponding to the first actual value. For example, the remote computing device 200 may determine the first expected value using the vehicle data.

At 408, the method 400 determines whether the first actual value is within a range of the first expected value. For example, the remote computing device 200 may determine whether the first actual value is within the range of the first expected value. If the remote computing device 200 determines that the first actual value is within the range of the first expected value, the method 400 continues at 402. Conversely, if the remote computing device 200 determines that the first actual value is outside the range of the first expected value, the method 400 continues at 410.

At 410, the method 400 generates a vehicle simulation corresponding to the segment. For example, the remote computing device 200 may generate the vehicle simulation corresponding to the segment of the vehicle operating session.

At 412, the method 400 provides, at one or more simulation interfaces, the vehicle simulation. For example, the remote computing device 200 may provide, at the one or more simulation interfaces, the vehicle simulation.

At 414, the method 400 generates, using the vehicle data, a score corresponding to at least the segment of the vehicle operating session. For example, the remote computing device 200 may generate, using the vehicle data, the score corresponding to at least the segment of the vehicle operating session.

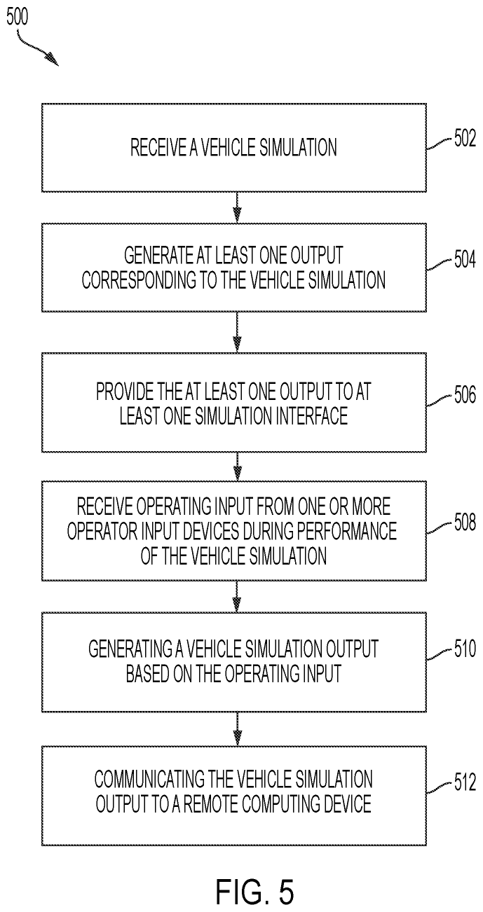

FIG. 5 is a flow diagram generally illustrating a vehicle operating simulation execution method 500 according to the principles of the present disclosure. At 502, the method 500 receives a vehicle simulation. For example, the controller 100 may receive the vehicle simulation from the remote computing device 200.

At 504, the method 500 generates at least one output corresponding to the vehicle simulation. For example, the controller 100 may generate at least one output corresponding to the vehicle simulation.

At 506, the method 500 provides the at least one output to at least one simulation interface. For example, the controller 100 may provide the at least one output to the at least one simulation interface.

At 508, the method 500 receives operating input from one or more operator input devices during performance of the vehicle simulation. For example, the controller 100 may receive the operating input from the one or more operator input during performance of the vehicle simulation.

At 510, the method 500 generates a vehicle simulation output past on the operating input. For example, the controller 100 may generate the vehicle simulation output based on the at least one operating input.

At 512, the method 500 communicates the vehicle simulation output to a remote computing device. For example, the controller 100 may communicate the vehicle simulation output to the remote computing device 200.

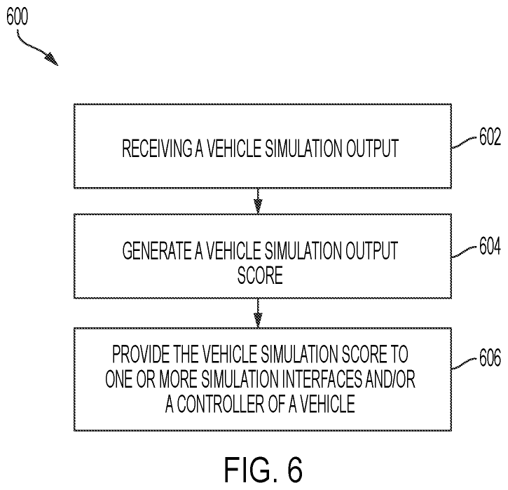

FIG. 6 is a flow diagram generally illustrating a vehicle operating simulation scoring method 600 according to the principles of the present disclosure. At 602, the method 600 receives a vehicle simulation output. For example, the remote computing device 200 may receive the vehicle simulation output from the controller 100.

At 604, the method 600 generates a vehicle simulation score. For example, the remote computing device 200 may generate the vehicle simulation score.

At 606, the method 600 provides the vehicle simulation score to one or more simulation interfaces and/or a controller of a vehicle. For example, the remote computing device 200 may provide the vehicle simulation score to the one or more simulation interfaces and/or to the controller 100. In some embodiments, the remote computing device 200 may provide the vehicle simulation score to an associated mobile computing device or other suitable computing device.

In some embodiments, a method for vehicle operating session simulation includes receiving, at a server computing device, vehicle data representing characteristics of a vehicle during a vehicle operating session and identifying a first actual value of the vehicle data corresponding to at least one operator input provided during a corresponding segment of the vehicle operating session. The method also includes determining, using the vehicle data, a first expected value corresponding to the first actual value and, in response to a determination that the first actual value is outside of a range of the first expected value, generating a vehicle simulation corresponding to the segment. The method also includes providing, at one or more simulation interfaces, the vehicle simulation.

In some embodiments, the one or more simulation interfaces includes one or more of a heads-up display of the vehicle, a display associated with an infotainment system of the vehicle, one or more enhanced reality devices, one or more audio output devices, one or more operator input devices of the vehicle, and a mobile computing device. In some embodiments, the one or more operator input devices of the vehicle includes at least one of a handwheel, an accelerator interface, a decelerator interface, and a signal indicator. In some embodiments, the vehicle data includes at least one of steering system data, vehicle propulsion data, global positioning data, environmental data, traffic data, and traffic control data. In some embodiments, the segment corresponds to a portion of the vehicle operating session that includes at least one of a vehicle turn, a vehicle stop, a vehicle acceleration, and a vehicle deceleration. In some embodiments, the vehicle operating session corresponds to a period of vehicle operation initiated in response to a first simulation mode input corresponding to a simulation mode interface. In some embodiments, the period of vehicle operation of the vehicle operating session concludes in response to a second simulation mode input. In some embodiments, the second simulation mode input corresponds to at least one of the simulation mode interface, vehicle position, a vehicle speed, a vehicle gear position, and an ignition switch position. In some embodiments, the method also includes generating, using the vehicle data, a vehicle operating session score. In some embodiments, the server computing device is remotely located from the vehicle.

In some embodiments, a system for vehicle operating session simulation includes a processor and a memory. The memory includes instructions that, when executed by the processor, cause the processor to: receive vehicle data representing characteristics of a vehicle during a vehicle operating session; identify a first actual value of the vehicle data corresponding to at least one operator input provided during a corresponding segment of the vehicle operating session; determine, using the vehicle data, a first expected value corresponding to the first actual value; in response to a determination that the first actual value is outside of a range of the first expected value, generate a vehicle simulation corresponding to the segment; and provide, at one or more simulation interfaces, the vehicle simulation.

In some embodiments, the one or more simulation interfaces includes one or more of a heads-up display of the vehicle, a display associated with an infotainment system of the vehicle, one or more enhanced reality devices, one or more audio output devices, one or more operator input devices of the vehicle, and a mobile computing device. In some embodiments, the one or more operator input devices of the vehicle includes at least one of a handwheel, an accelerator interface, a decelerator interface, and a signal indicator. In some embodiments, the vehicle data includes at least one of steering system data, vehicle propulsion data, global positioning data, environmental data, traffic data, and traffic control data. In some embodiments, the segment corresponds to a portion of the vehicle operating session that includes at least one of a vehicle turn, a vehicle stop, a vehicle acceleration, and a vehicle deceleration. In some embodiments, the vehicle operating session corresponds to a period of vehicle operation initiated in response to a first simulation mode input corresponding to a simulation mode interface. In some embodiments, the period of vehicle operation of the vehicle operating session concludes in response to a second simulation mode input. In some embodiments, the second simulation mode input corresponds to at least one of the simulation mode interface, vehicle position, a vehicle speed, a vehicle gear position, and an ignition switch position. In some embodiments, the instructions further case the processor to generate, using the vehicle data, a vehicle operating session score. In some embodiments, the server computing device is remotely located from the vehicle.

In some embodiments, an apparatus for vehicle operating session simulation includes a processor and a memory. The memory includes instructions that, when executed by the processor, cause the processor to: receive, from a controller associated with a vehicle, vehicle data representing characteristics of the vehicle during a vehicle operating session, the vehicle data being generated by the controller in response to a simulation mode input indicating a start of the vehicle operating session; identify a first actual value of the vehicle data corresponding to at least one operator input provided during a corresponding segment of the vehicle operating session, the at least one operator input being associated with at least one component of a steering system of the vehicle; determine, using the vehicle data, a first expected value corresponding to the first actual value; in response to a determination that the first actual value is outside of a range of the first expected value, generate a vehicle simulation corresponding to the segment; and provide, at one or more simulation interfaces, the vehicle simulation.

The word “example” is used herein to mean serving as an example, instance, or illustration. Any aspect or design described herein as “example” is not necessarily to be construed as preferred or advantageous over other aspects or designs. Rather, use of the word “example” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same embodiment or implementation unless described as such.

Implementations the systems, algorithms, methods, instructions, etc., described herein can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors, or any other suitable circuit. In the claims, the term “processor” should be understood as encompassing any of the foregoing hardware, either singly or in combination. The terms “signal” and “data” are used interchangeably.

As used herein, the term module can include a packaged functional hardware unit designed for use with other components, a set of instructions executable by a controller (e.g., a processor executing software or firmware), processing circuitry configured to perform a particular function, and a self-contained hardware or software component that interfaces with a larger system. For example, a module can include an application specific integrated circuit (ASIC), a Field Programmable Gate Array (FPGA), a circuit, digital logic circuit, an analog circuit, a combination of discrete circuits, gates, and other types of hardware or combination thereof. In other embodiments, a module can include memory that stores instructions executable by a controller to implement a feature of the module.

Further, in one aspect, for example, systems described herein can be implemented using a general-purpose computer or general-purpose processor with a computer program that, when executed, carries out any of the respective methods, algorithms, and/or instructions described herein. In addition, or alternatively, for example, a special purpose computer/processor can be utilized which can contain other hardware for carrying out any of the methods, algorithms, or instructions described herein.

Further, all or a portion of implementations of the present disclosure can take the form of a computer program product accessible from, for example, a computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are also available.

The above-described embodiments, implementations, and aspects have been described in order to allow easy understanding of the present disclosure and do not limit the present disclosure. On the contrary, the disclosure is intended to cover various modifications and equivalent arrangements included within the scope of the appended claims, which scope is to be accorded the broadest interpretation to encompass all such modifications and equivalent structure as is permitted under the law.

What is claimed is:

1. A method for vehicle operating session simulation, the method comprising:
receiving, at a server computing device, vehicle data representing characteristics of a vehicle during a vehicle operating session;
identifying a first actual value of the vehicle data corresponding to at least one operator input provided during a corresponding segment of the vehicle operating session;
determining, using the vehicle data, a first expected value corresponding to the first actual value;
in response to a determination that the first actual value is outside of a range of the first expected value, generating a vehicle simulation corresponding to the segment; and
providing, at one or more simulation interfaces, the vehicle simulation.

2. The method of claim 1, wherein the one or more simulation interfaces includes one or more of a heads-up display of the vehicle, a display associated with an infotainment system of the vehicle, one or more enhanced reality devices, one or more audio output devices, one or more operator input devices of the vehicle, and a mobile computing device.

3. The method of claim 2, wherein the one or more operator input devices of the vehicle includes at least one of a handwheel, an accelerator interface, a decelerator interface, and a signal indicator.

4. The method of claim 1, wherein the vehicle data includes at least one of steering system data, vehicle propulsion data, global positioning data, environmental data, traffic data, and traffic control data.

5. The method of claim 1, wherein the segment corresponds to a portion of the vehicle operating session that includes at least one of a vehicle turn, a vehicle stop, a vehicle acceleration, and a vehicle deceleration.

6. The method of claim 1, wherein the vehicle operating session corresponds to a period of vehicle operation initiated in response to a first simulation mode input corresponding to a simulation mode interface.

7. The method of claim 6, wherein the period of vehicle operation of the vehicle operating session concludes in response to a second simulation mode input.

8. The method of claim 7, wherein the second simulation mode input corresponds to at least one of the simulation mode interface, vehicle position, a vehicle speed, a vehicle gear position, and an ignition switch position.

9. The method of claim 1, further comprising generating, using the vehicle data, a vehicle operating session score.

10. The method of claim 1, wherein the server computing device is remotely located from the vehicle.

11. A system for vehicle operating session simulation, the system comprising:
a processor; and
a memory including instructions that, when executed by the processor, cause the processor to:
receive vehicle data representing characteristics of a vehicle during a vehicle operating session;
identify a first actual value of the vehicle data corresponding to at least one operator input provided during a corresponding segment of the vehicle operating session;
determine, using the vehicle data, a first expected value corresponding to the first actual value;
in response to a determination that the first actual value is outside of a range of the first expected value, generate a vehicle simulation corresponding to the segment; and
provide, at one or more simulation interfaces, the vehicle simulation.

12. The system of claim 11, wherein the one or more simulation interfaces includes one or more of a heads-up display of the vehicle, a display associated with an infotainment system of the vehicle, one or more enhanced reality devices, one or more audio output devices, one or more operator input devices of the vehicle, and a mobile computing device.

13. The system of claim 12, wherein the one or more operator input devices of the vehicle includes at least one of a handwheel, an accelerator interface, a decelerator interface, and a signal indicator.

14. The system of claim 11, wherein the vehicle data includes at least one of steering system data, vehicle propulsion data, global positioning data, environmental data, traffic data, and traffic control data.

15. The system of claim 11, wherein the segment corresponds to a portion of the vehicle operating session that includes at least one of a vehicle turn, a vehicle stop, a vehicle acceleration, and a vehicle deceleration.

16. The system of claim 11, wherein the vehicle operating session corresponds to a period of vehicle operation initiated in response to a first simulation mode input corresponding to a simulation mode interface.

17. The system of claim 16, wherein the period of vehicle operation of the vehicle operating session concludes in response to a second simulation mode input.

18. The system of claim 17, wherein the second simulation mode input corresponds to at least one of the simulation mode interface, vehicle position, a vehicle speed, a vehicle gear position, and an ignition switch position.

19. The system of claim 11, wherein the instructions further cause the processor to generate, using the vehicle data, a vehicle operating session score.

20. An apparatus for vehicle operating session simulation, the apparatus comprising:
a processor; and
a memory including instructions that, when executed by the processor, cause the processor to:
receive, from a controller associated with a vehicle, vehicle data representing characteristics of the vehicle during a vehicle operating session, the vehicle data being generated by the controller in response to a simulation mode input indicating a start of the vehicle operating session;
identify a first actual value of the vehicle data corresponding to at least one operator input provided during a corresponding segment of the vehicle operating session, the at least one operator input being associated with at least one component of a steering system of the vehicle;
determine, using the vehicle data, a first expected value corresponding to the first actual value;
in response to a determination that the first actual value is outside of a range of the first expected value, generate a vehicle simulation corresponding to the segment; and
provide, at one or more simulation interfaces, the vehicle simulation.
